(19) United States
(12) Patent Application Publication
(10) Pub. No.: US 2007/0038757 A1
(43) Pub. Date: Feb. 15, 2007

(54) Client and presentation layer architecture for session initiation protocol-based applications

(75) Inventor: Venkatesh Raju, Richardson, TX (US)

Correspondence Address: CONLEY ROSE, P.C., 5700 GRANITE PARKWAY, SUITE 330, PLANO, TX, 75024, US

(73) Assignee: Samsung Electronics Co., Ltd.

(21) Appl. No.: 11/270,966

(22) Filed: Nov. 11, 2005

Related U.S. Application Data
(60) Provisional application No. 60/707,659, filed on Aug. 12, 2005.

(51) Int. Cl. G06F 15/16

(52) U.S. Cl. 709/227

(57) ABSTRACT

The present disclosure provides a web browser having an HTTP client and a SIP user agent. The HTTP client is operable to receive and render data transmitted via hypertext transfer protocol (HTTP) communication protocol. The SIP user agent is operable to receive and render data transmitted via session initiation protocol (SIP) communication protocol.

### CROSS-REFERENCE TO RELATED APPLICATIONS

This application claims priority to U.S. Provisional Application No. 60/707,659 filed Aug. 12, 2005, entitled “Client And Presentation Layer Architecture For Session Initiation Protocol (SIP) based Applications,” by Venkatesh Raju, et a/, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure relates to Session Initiation Protocol-based applications. More specifically, but not by way of limitation, a method and system are provided that allow the integration of Session Initiation Protocol-based applications into a web browser.

### BACKGROUND OF THE INVENTION

The Internet Engineering Task Force developed the Session Initiation Protocol (SIP) as a standard protocol for initiating, maintaining, modifying, and terminating session-based communications. SIP is often used for Internet Protocol (IP) telephone calls but can also be used for other types of interactive and multimedia sessions such as video conferences, chat sessions, instant messaging sessions, and games. As used herein, terms such as ‘SIP session’, ‘SIP-based message’, and the like will be used to refer to any data transfer or communication that is promoted by or initiated through SIP, even though the actual transport of data in a session initiated through SIP may occur through Realtime Transport Protocol or otherwise.

### SUMMARY OF THE INVENTION

In one embodiment, a web browser is disclosed having an HTTP client and a SIP user agent. The HTTP client is operable to receive and render data transmitted via hypertext transfer protocol (HTTP) communication protocol. The SIP user agent is operable to receive and render data transmitted via session initiation protocol (SIP) communication protocol.

In another embodiment, a data communication architecture is provided that includes a server and client components. The server component is operable to store and transmit service logic data and presentation logic data related to an application. At least some of the information used by the application is communicated using session initiation protocol. The client component is operable to receive the information from the application communicated using session initiation protocol from the server component. The client component is further operable to promote use of the information by a web browser.

In yet another embodiment, a method for enabling a web browser for session initiation protocol is provided. The method includes providing a web browser having a SIP component, and transmitting information using session initiation protocol to the web browser. The method also includes the SIP component promoting use of the information by the web browser.

These and other features and advantages will be more clearly understood from the following detailed description taken in conjunction with the accompanying drawings and claims.

### BRIEF DESCRIPTION OF THE DRAWINGS

For a more complete understanding of the presentation and the advantages thereof, reference is now made to the following brief description, taken in connection with the accompanying drawings in detailed description, wherein like reference numerals represent like parts.

FIG. 1 illustrates a data communication architecture according to an embodiment of the present disclosure.

FIG. 2 is a flow-chart of a method for using SIP in a web browser, according to one embodiment of the present disclosure.

FIG. 3 is a diagram of an exemplary computer system operable for implementation of some of the various embodiments.

### DETAILED DESCRIPTION OF THE PREFERRED EMBODIMENTS

It should be understood at the outset that although an exemplary implementation of one embodiment of the present invention is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

SIP-based applications are typically executed on computers, mobile telephones, personal digital assistants (PDAs), and similar devices. Under current technology, a different SIP-based application is typically installed on such a device for one or more of the different SIP-based function that the device is to perform. For example, one or more voice over IP (VoIP) telephony applications, one or more video conferencing applications, one or more instant messaging applications, and so on might be installed on a device. Such a profusion of applications might be acceptable on a computer but is typically undesirable on a mobile telephone or PDA. Due to the limited processing power, memory, and screen size of mobile telephones and PDAs, it is typically preferable to limit the number of application installed on such devices.

In addition, the installation of a SIP-based application on a device can create challenges when upgrades or patches are made to the application. When an upgrade needs to be made to a SIP-based application that is in wide use, the vendor of the application might need to distribute large quantities of the new version of the application to its customers. The customers might then be responsible for installing the patch or upgrade on the device. Since some customers might choose not to install a new version of an application, the vendor typically needs to continue to support the previous versions.

In an embodiment of the present disclosure, SIP-based functions are integrated into a standard web browser that might be found on a computer, mobile telephone, PDA, or similar device. In addition to standard web access functions, the user interface of the browser can be used to access multiple SIP-based applications such as an IP telephony telephone call, a video presentation such as a video conference, a text-based communication such as instant messaging, an interactive game, a location-based service such as an application customized based on a user's location as determined by a global positioning system, a shopping service such as an online auction, and other session-based applications familiar to one of skill in the art. The service logic and presentation logic for the applications reside on a server with which the device can communicate. Data is passed between the server and the device so that a user can perform SIP-based functions via the browser in a similar manner as if the SIP-based applications were installed on the device.

Such an arrangement can reduce the number of applications that are installed on a mobile telephone or PDA. Instead of a separate, standalone application being installed on the mobile telephone or PDA for each desired SIP-based capability, a single browser can allow access to multiple SIP-based applications installed on the server. This architecture can also facilitate the distribution of a new version of an application. Rather than distributing multiple copies of an application to multiple customers, a vendor can simply upgrade a SIP-based application on the server and the upgraded version will then be available to the customers via a web browser. In this case, only the SIP enabled web browser may need to be occasionally updated. Thus, whether implemented on hand-held devices, computers, or other systems, SIP enabled browser based-applications are significantly easier to manage and upgrade as opposed to having multiple independent applications.

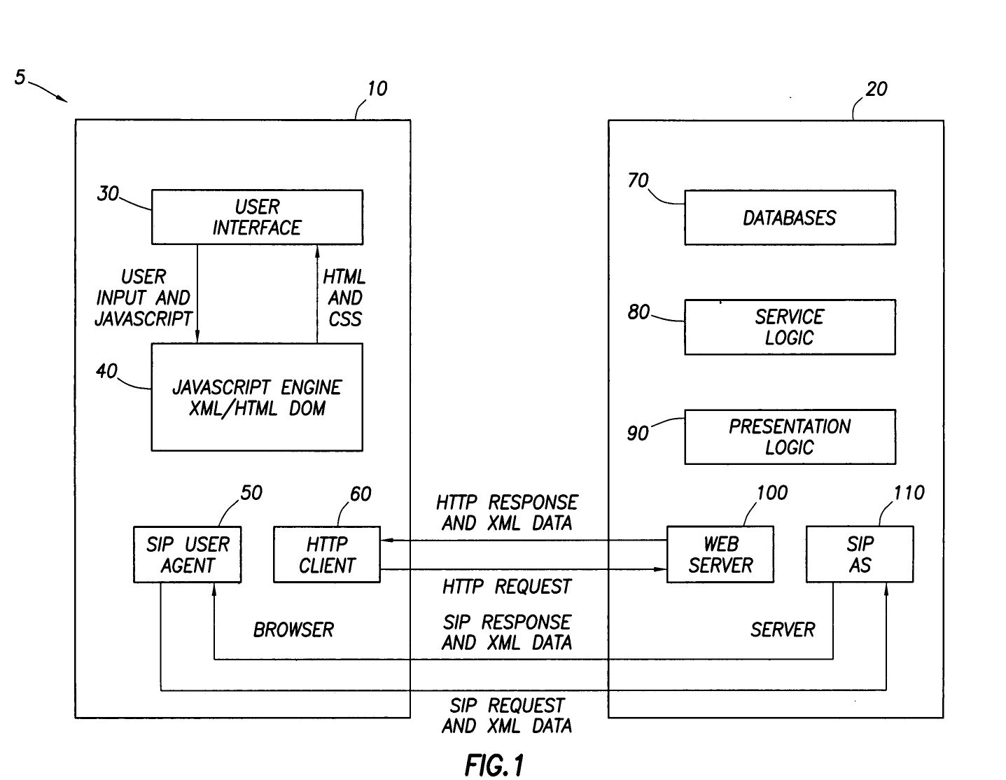

FIG. 1 illustrates an embodiment of such a data communication architecture 5. The architecture 5 includes a client component 10 and a server component 20. The client component 10 includes a user interface 30, a JavaScript engine 40 that includes an XML/HTML document object model (DOM), a SIP user agent 50, and an HTTP client 60. The server component 20 includes one or more databases 70, a service logic component 80, a presentation logic component 90, a web server component 100, and a SIP application server component 110.

The HTTP client 60 on the client component 10 can communicate with the web server 100 on the server component 20 to perform standard web-based functions such as the display of web pages. The SIP user agent 50 on the client component 10 can communicate with the SIP application server 110 on the server component 20 to perform SIP-based functions such as VoIP, video conferencing, and instant messaging.

The SIP-based functions are carried out by means of the databases 70, the service logic component 80, and the presentation logic component 90. The databases 70 contain the content that is used by the SIP-based applications. The service logic component 80, which might also be referred to as a business logic component, carries out the functions provided by the SIP-based applications. In an embodiment, service logic is implemented with a high-level scripting language such as JavaScript. In other embodiments, other languages could be used. Files containing the service logic might be stored on the SIP application server 110. When a SIP-based application is invoked, service logic data is transmitted from the SIP application server 110 to the SIP user agent 50 for execution.

The presentation logic component 90 defines the appearance of the SIP-based applications on a web browser. The presentation logic may be defined using HTML, XHTML and CSS, XML-based user interface languages such as XUL or XAML, or high-level programming languages. Files containing the presentation logic might be stored on the SIP application server 110. When a SIP-based application is invoked, presentation logic data is transmitted from the SIP application server 110 to the SIP user agent 50 for rendering and display on a web browser.

In the client component 10, the JavaScript engine 40 can interpret and execute the JavaScript code received from the server component 20. In other embodiments, where high-level languages other than JavaScript are used on the server component 20, other appropriate engines may be present in the client component 10. The engine 40 contains a DOM that has been extended to support SIP. In other words, the client component 10 includes a SIP protocol stack in addition to an HTTP protocol stack.

The user interface 30 can be a standard web browser interface that can send user input and JavaScript code or other code to the engine 40. The user interface 30 can receive data from the engine 40 in an HTML format, a cascading style sheet (CSS) format, or other presentation language format, and can create a display based on the received data. The use of a single interface 30 for multiple web-based and SIP-based applications provides a unified look and feel to a user for all of the applications. Since the presentation logic 90 for the user interface 30 is deployed on the server component 20, all users with access to a SIP-enabled browser can see substantially the same user interface 30. A SIP-enabled browser might be installed on a computer, a telephone, a PDA, a television, or similar devices capable of displaying graphical information.

The SIP-enabled browser allows users to initiate and release SIP sessions via standard SIP transactions, such as the INVITE, BYE, and CANCEL commands. These commands can be mapped to existing input mechanisms for HTTP requests in the browser, such as ‘Go’ and ‘Stop’ buttons. The SIP browser also supports other SIP transactions such as INFO, re-INVITE, REFER, UPDATE, and MESSAGE. These commands might also be initiated via mechanisms in the browser such as menu items or buttons. To allow access to the SIP stack and transactions, the SIP browser also provides objects similar to the XML HttpRequest object provided by most modern web browsers. These SIP transaction objects allow the user to initiate and respond to SIP transactions using JavaScript and allow application-specific logic to be implemented on the client. This mechanism is similar to the Asynchronous JavaScript and XML (AJAX) model.

Since SIP is a peer-to-peer protocol, SIP-based applications typically need to be able to both initiate and respond to requests. In an embodiment, the SIP-based browser is capable of initiating outbound SIP requests and responding to inbound SIP requests in addition to being capable of initiating standard outbound HTTP requests. The browser can include mechanisms to report incoming requests, such as INVITE or CANCEL, to the user. The user can manually respond to the requests through the web browser or the browser can respond to the requests automatically.

As an example, a SIP-based browser such as that described above might be used for participation in an online auction. In contrast with current online auctions where a static image of an object for sale is typically displayed, in a SIP-based auction a video presentation of the object could be made where the object might be shown from various angles. In addition, participants in the auction could be videotaped and their images could be displayed in the web browsers of other participants. A participant might place a bid in the standard manner via buttons in the browser, or might place a bid via a VoIP call.

To participate in such an auction, a user might open a SIP-enabled browser and navigate to the auction web site using standard HTTP-based commands. Both HTTP-based and SIP-based information might then be transmitted to the browser. For example, HTTP might be used to send text and graphical data and SIP might be used to send video data. HTTP might also be used to display a simulated telephone in the browser, including a keypad, text entry fields, and other input means needed to make a VoIP phone call. If the user placed a call via the simulated telephone, the call might be initiated through SIP. Thus, the HTTP-based functions and the SIP-based functions would be seamlessly integrated into the browser and the user would not necessarily know which functions were HTTP-based and which were SIP-based.

The use of such a SIP-based web browser and its accompanying data communication architecture eliminates the need for installing separate applications on a client to obtain the desired SIP-based capability. The applications can be installed on a server and accessed as needed by multiple clients. If upgrades are necessary to an application, the modifications can be made one time on the server rather than multiple times on multiple clients. The clients will automatically use the latest version of an application without any action needed by the clients. The server does not need to support multiple versions of an application because all of the clients will use the same version.

Such a data communication architecture also provides benefits to developers of SIP-based applications. Since the service logic and presentation logic for the applications are installed on a server rather than on multiple clients, developers do not need to create and test different versions of applications for different client platforms. A high-level programming language might use a set of standard commands that allow developers to specify the functions to be carried out without the developers necessarily being aware of whether the functions are SIP-based or HTTP-based.

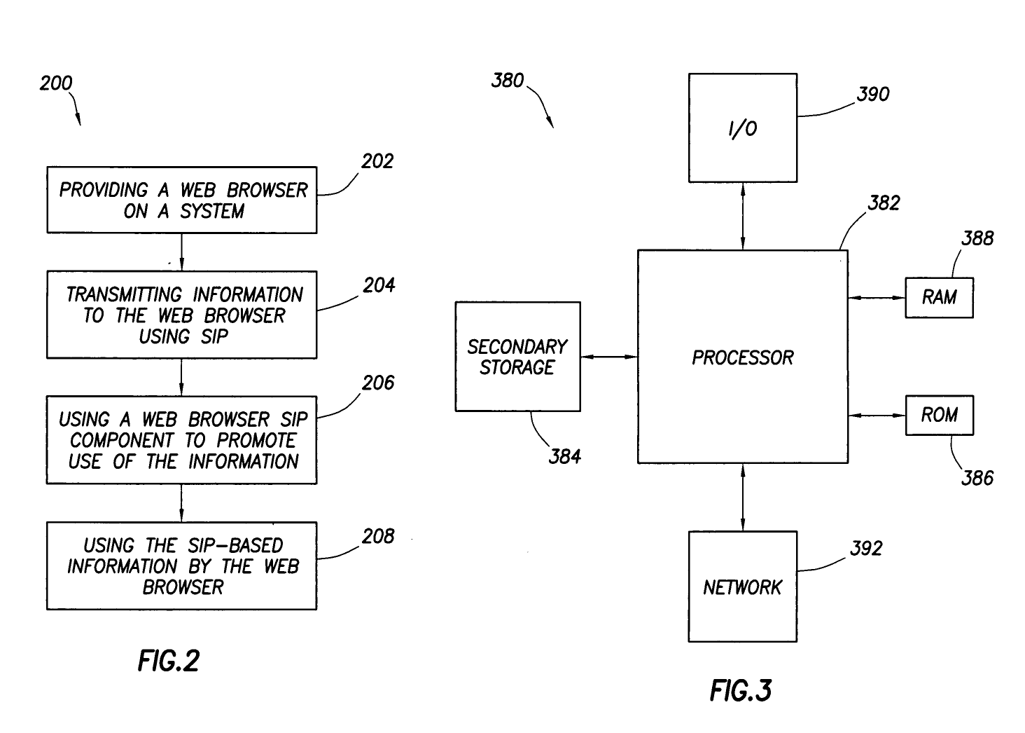

FIG. 2 illustrates a flow-chart of a method 200 for using a web browser to enable communication via session initiation protocol, according to one embodiment of the present disclosure. At a block 202, the method includes providing a web browser on a system. The system may be, for example, a mobile telephone handset, personal digital assistant, or other portable computing or telecommunications device, a desktop or laptop computer, or other such systems. At a block 204, the method includes transmitting information to the browser using session initiation protocol (SIP). This information may be provided using a server based application by using the server 20 and related components as illustrated above.

The method also includes, at a block 206, using a SIP component of the browser to promote use by the web browser of the SIP-based information. At a block 208, the method provides for using, such as displaying or otherwise, at least some of the SIP-based information in the web browser.

According to some embodiments, the client component 10 may operate on a personal computer running the SIP enabled browser as its web browser, and/or the server component 20 may operate on a computer system operating the web server 100, SIP application server 110, and other disclosed components. In these and another other embodiments, which will readily suggest themselves to one skilled in the art, the systems may be implemented on any general-purpose computer with sufficient processing power, memory resources, and network throughput capability to handle the necessary workload placed upon it. FIG. 3 illustrates a typical, general-purpose computer system suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) 390 devices, and network connectivity devices 392. The processor may be implemented as one or more CPU chips.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage. The RAM 388 is used to store volatile data and perhaps to store instructions. Access to both ROM 386 and RAM 388 is typically faster than to secondary storage 384.

I/O 390 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 392 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 392 devices may enable the processor 382 to communicate with an Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave

Such information, which may include data or instructions to be executed using processor 382 for example, may be received from and outputted to the network, for example, in the form of a computer data baseband signal or signal embodied in a carrier wave. The baseband signal or signal embodied in the carrier wave generated by the network connectivity 392 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 382 executes instructions, codes, computer programs, scripts which it accesses from hard disk, floppy disk, optical disk (these various disk based systems may all be considered secondary storage 384), ROM 386, RAM 388, or the network connectivity devices 392.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A web browser, comprising:
an HTTP client operable to receive and render data transmitted via HTTP communication protocol; and
a SIP user agent operable to send data via session initiation protocol (SIP) communication protocol and further operable to receive and render data transmitted via SIP.

2. The web browser of claim 1 wherein the data received via SIP communication protocol comprises service logic data and presentation logic data related to an application resident on different system than the system whereon the web browser is resident.

3. The web browser of claim 1 further comprising a document object model that has been extended to support SIP communication.

4. The web browser of claim 1 further comprising an engine operable to execute a script that implements the service logic data.

5. The web browser of claim 4 further comprising at least one mechanism operable to initiate and respond to SIP-based messages.

6. The web browser of claim 1 wherein the web browser is implemented on at least one of:
a computer system;
a mobile telephone handset;
a personal digital assistant; and
a television.

7. A data communication architecture, comprising:
a server component operable to store and transmit service logic data and presentation logic data related to an application, at least some of the information used by the application communicated using session initiation protocol; and
a client component operable to receive the information from the application communicated using session initiation protocol from the server component, the client component further operable to promote use of the information by a web browser.

8. The architecture of claim 7 wherein the server component is further operable to store and transmit data that follows an HTTP-based communication protocol and the client component is further operable to update the display in the web browser based on the HTTP-based data.

9. The architecture of claim 7 wherein the client component is further operable to initiate and respond to a session initiation protocol message.

10. The architecture of claim 7 wherein the client component further comprises a document object model that has been extended to support session initiation protocol communication.

11. The architecture of claim 7 wherein the service logic data is implemented with a high-level scripting language.

12. The architecture of claim 7 wherein the client component is further operable to execute the service logic data implemented with the high-level scripting language.

13. The architecture of claim 7 further comprising a system operable to implement the client component and the web browser, and wherein the system is further defined as a system selected from a group consisting of a computer system, a mobile telephone handset, a personal digital assistant, and a television.

14. A method for enabling a web browser for session initiation protocol, comprising:
providing a web browser having a SIP component;
the web browser communicating information via session initiation protocol; and
the SIP component promoting use of the information by the web browser.

15. The method of claim 14, further comprising:
implementing service logic data and presentation logic data for an application on a server;
transmitting using session initiation protocol the service logic data and presentation logic data from the server to the web browser on a client; and
updating a display on the web browser based on the service logic data and presentation logic data.

16. The method of claim 15, wherein the application enables at least one of:
an IP telephony telephone call;
a video presentation;
a text-based communication;
a game;
a location-based service; and
a shopping service.

17. The method of claim 15 further comprising updating the display of the web browser based on HTTP-based data transmitted from the server.

18. The method of claim 15 further comprising transmitting data for a user interface for the SIP-based application via HTTP.

19. The method of claim 14, wherein the web browser is provided on a system selected from a group consisting of a computer system, a mobile telephone handset, a personal digital assistant, and a television

20. The method of claim 14, wherein the SIP component promoting use of the information by the web browser is further defined as the SIP component promoting the web browser displaying at least some of the information.
